(19) United States
(12) Patent Application Publication
(10) Pub. No.: US 2025/0210243 A1
(43) Pub. Date: Jun. 26, 2025

(54) MAGNETIC COMPONENT

(71) Applicant: Delta Electronics, Inc., Taoyuan City (TW)

(72) Inventors: Chun-Yu Yang, Taoyuan City (TW); Meng-Chi Tsai, Taoyuan City (TW)

(21) Appl. No.: 18/436,291

(22) Filed: Feb. 8, 2024

(30) Foreign Application Priority Data
Dec. 26, 2023 (CN) 202311805013.1

(51) Int. Cl. H01F 27/26; H01F 27/02; H01F 27/30

(52) U.S. Cl. CPC H01F 27/26; H01F 27/02; H01F 27/306

(57) ABSTRACT

A magnetic component is provided. The cross-sectional area of each lateral core part of the magnetic component is less than or equal to the cross-sectional area of the first middle core part. The magnetic component generates nonlinear inductance variations at different currents for achieving different coupling coefficients. Consequently, when the magnetic component operates at low current, the magnetic component maintains a non-coupled high inductance. On the other hand, when the magnetic component operates at high current, the magnetic component achieves high saturation and reduced inductance by the lateral core parts of the magnetic component. Simultaneously, the coupling degree is increased automatically, the AC current peak is reduced, and the magnetic flux is evenly distributed on the upper cover core part or the lower cover core part. Consequently, the magnetic component has advantage of reducing the component loss and the conduction loss in the power supply.

### CROSS-REFERENCE TO RELATED APPLICATION

This application claims priority to China Patent Application No. 202311805013.1 filed on Dec. 26, 2023, the entire contents of which are incorporated herein by reference for all purposes.

### FIELD OF THE INVENTION

The present disclosure relates to a magnetic component, and more particularly to a magnetic component including lateral core parts.

### BACKGROUND OF THE INVENTION

Nowadays, under the demand for high power density, the volume of the power supply is decreased, so it is needed to reduce the volume of the inductors within the power supply. For achieving better efficiency under compact size of the inductor, the ferrite core is typically used as the inductor. However, the ferrite core has characteristics of reduced loss and easy to be saturation. For maintaining the power efficiency and solving the saturation issue, it is necessary to reduce the inductance of the ferrite core, but meanwhile, the inductor current of the ferrite core is increased and the conduction loss of the power supply is enhanced simultaneously.

Therefore, there is a need of providing a magnetic component to obviate the drawbacks encountered from the prior arts.

### SUMMARY OF THE INVENTION

The present disclosure provides a magnetic component. The cross-sectional area of each lateral core part of the magnetic component of the present disclosure is less than or equal to the cross-sectional area of the first middle core part. The magnetic component generates nonlinear inductance variations at different currents for achieving different coupling coefficients. Consequently, when the magnetic component operates at low current, the magnetic component maintains a non-coupled high inductance. On the other hand, when the magnetic component operates at high current, the magnetic component achieves saturation and reduced inductance by the lateral core parts of the magnetic component. Simultaneously, the coupling degree is increased automatically, the AC current peak is reduced, and the magnetic flux is evenly distributed on the upper cover core part or the lower cover core part. Consequently, the magnetic component of the present disclosure has advantage of reducing the component loss and the conduction loss in the power supply.

In accordance with an aspect of the present disclosure, there is provided a magnetic component. The magnetic component includes a magnetic core assembly and a winding assembly. The magnetic core assembly includes an upper cover core part, a lower cover core part, a first middle core part, a second middle core part and a first lateral core part. The upper cover core part includes a plurality of lateral walls. The lower cover core part and the upper cover core part are opposite to each other. The first middle core part is disposed between the upper cover core part and the lower cover core part. A first distance is formed between the first middle core part and any one of the plurality of lateral walls of the upper cover core part. The second middle core part is disposed between the upper cover core part and the lower cover core part. A second distance is formed between the second middle core part and any one of the plurality of lateral walls of the upper cover core part. A third distance is formed between the second middle core part and the first middle core part. The first lateral core part is disposed between the upper cover core part and the lower cover core part and connected with at least one of the plurality of lateral walls of the upper cover core part. A cross-sectional area of the first lateral core part is less than or equal to a cross-sectional area of the first middle core part. The winding assembly includes a first winding and a second winding. The first winding is disposed around the first middle core part. The second winding is disposed around the second middle core part.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic view illustrating a magnetic component according to a first embodiment of the present disclosure;

FIG. 2 is a schematic exploded view illustrating the magnetic component of FIG. 1;

FIG. 3 is a schematic cross-sectional diagram illustrating an upper cover core part of a magnetic core assembly of the magnetic component of FIG. 1;

FIG. 4 is a schematic view illustrating a magnetic component according to a second embodiment of the present disclosure;

FIG. 5 is a schematic exploded view illustrating the magnetic component of FIG. 4; and

FIG. 6 is a schematic cross-sectional diagram illustrating an upper cover core part of a magnetic core assembly of the magnetic component of FIG. 4.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

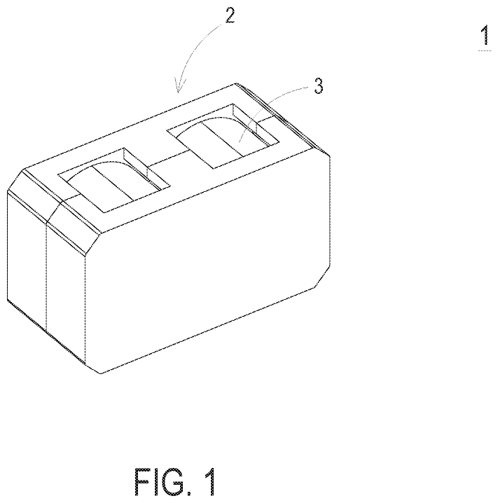

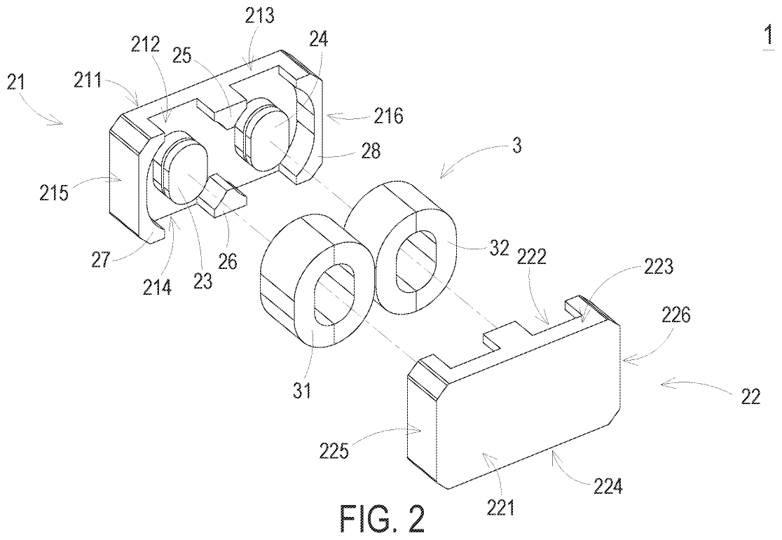

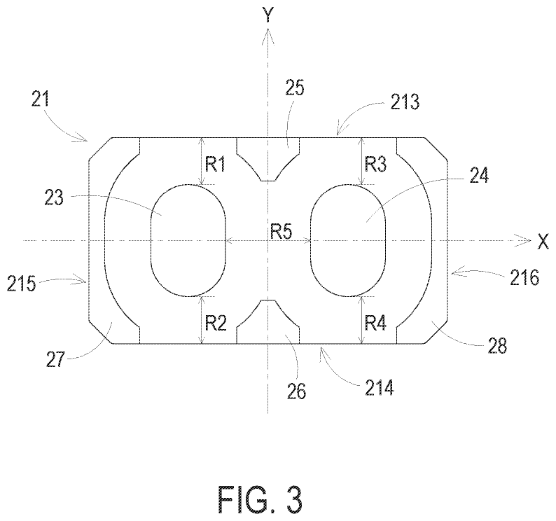

FIG. 1 is a schematic view illustrating a magnetic component according to a first embodiment of the present disclosure. FIG. 2 is a schematic exploded view illustrating the magnetic component of FIG. 1. FIG. 3 is a schematic cross-sectional diagram illustrating an upper cover core part of a magnetic core assembly of the magnetic component of FIG. 1. As shown in FIGS. 1 to 3, the magnetic component 1 of this embodiment includes a magnetic core assembly 2 and a winding assembly 3. The magnetic core assembly 2 is a ferrite core assembly and includes an upper cover core part 21, a lower cover core part 22, a first middle core part 23, a second middle core part 24, a first lateral core part 25, a second lateral core part 26, a third lateral core part 27 and a fourth lateral core part 28.

The upper cover core part 21 includes an upper surface 211, a lower surface 212, a first lateral wall 213, a second lateral wall 214, a third lateral wall 215 and a fourth lateral wall 216. The upper surface 211 and the lower surface 212 of the upper cover core part 21 are opposite to each other. The first lateral wall 213 and the second lateral wall 214 of the upper cover core part 21 are opposite to each other and disposed between the upper surface 211 and the lower surface 212 of the upper cover core part 21. The third lateral wall 215 and the fourth lateral wall 216 of the upper cover core part 21 are opposite to each other, disposed between the upper surface 211 and the lower surface 212 of the upper cover core part 21 and disposed between the first lateral wall 213 and the second lateral wall 214 of the upper cover core part 21. The lower cover core part 22 includes an upper surface 221, a lower surface 222, a first lateral wall 223, a second lateral wall 224, a third lateral wall 225 and a fourth lateral wall 226. The upper surface 221 and the lower surface 222 of the lower cover core part 22 are opposite to each other. The lower surface 222 of the lower cover core part 22 is disposed between the lower surface 212 of the upper cover core part 21 and the upper surface 221 of the lower cover core part 22. The first lateral wall 223 and the second lateral wall 224 of the lower cover core part 22 are opposite to each other and disposed between the upper surface 221 and the lower surface 222 of the lower cover core part 22. The third lateral wall 225 and the fourth lateral wall 226 of the lower cover core part 22 are opposite to each other, disposed between the upper surface 221 and the lower surface 222 of the lower cover core part 22 and disposed between the first lateral wall 223 and the second lateral wall 224 of the lower cover core part 22. As shown in FIG. 2, the upper surface 211, the lower surface 212, the first lateral wall 213, the second lateral wall 214, the third lateral wall 215 and the fourth lateral wall 216 of the upper cover core part 21 are symmetric to the upper surface 221, the lower surface 222, the first lateral wall 223, the second lateral wall 224, the third lateral wall 225 and the fourth lateral wall 226 of the lower cover core part 22, respectively. The upper cover core part 21 is described below for explaining the structure of the cover core part as an example. It is noted that the lower cover core part 22 is symmetric to the upper cover core part 21, and is not redundantly described hereinafter.

The first middle core part 23 is disposed between the lower surface 212 of the upper cover core part 21 and the lower surface 222 of the lower cover core part 22. Distances are formed between the first middle core part 23 and the first lateral wall 213 of the upper cover core part 21, formed between the first middle core part 23 and the second lateral wall 214 of the upper cover core part 21, and formed between the first middle core part 23 and the third lateral wall 215 of the upper cover core part 21. As shown in FIG. 3, a distance R1 is formed between the first middle core part 23 and the first lateral wall 213 of the upper cover core part 21. A distance R2 is formed between the first middle core part 23 and the second lateral wall 214 of the upper cover core part 21. The distance R1 formed between the first middle core part 23 and the first lateral wall 213 of the upper cover core part 21 is equal to the distance R2 formed between the first middle core part 23 and the second lateral wall 214 of the upper cover core part 21.

The second middle core part 24 is disposed between the lower surface 212 of the upper cover core part 21 and the lower surface 222 of the lower cover core part 22. Distances are formed between the second middle core part 24 and the first lateral wall 213 of the upper cover core part 21, formed between the second middle core part 24 and the second lateral wall 214 of the upper cover core part 21, and formed between the second middle core part 24 and the third lateral wall 215 of the upper cover core part 21. As shown in FIG. 3, a distance R3 is formed between the second middle core part 24 and the first lateral wall 213 of the upper cover core part 21. A distance R4 is formed between the second middle core part 24 and the second lateral wall 214 of the upper cover core part 21. The distance R3 formed between the second middle core part 24 and the first lateral wall 213 of the upper cover core part 21 is equal to the distance R4 formed between the second middle core part 24 and the second lateral wall 214 of the upper cover core part 21. In this embodiment, a distance R5 is formed between the first middle core part 23 and the second middle core part 24. The cross-sectional area of the first middle core part 23 is equal to the cross-sectional area of the second middle core part 24.

The first lateral core part 25 is disposed between the lower surface 212 of the upper cover core part 21 and the lower surface 222 of the lower cover core part 22. The first lateral core part 25 is connected with the first lateral wall 213 of the upper cover core part 21. The cross-sectional area of the first lateral core part 25 is less than or equal to half of the cross-sectional area of the first middle core part 23.

The second lateral core part 26 is disposed between the lower surface 212 of the upper cover core part 21 and the lower surface 222 of the lower cover core part 22. The second lateral core part 26 is connected with the second lateral wall 214 of the upper cover core part 21. The second lateral core part 26 and the first lateral core part 25 are opposite to each other. The cross-sectional area of the second lateral core part 26 is less than or equal to half of the cross-sectional area of the first middle core part 23. In this embodiment, as shown in FIG. 3, a first line X is formed from the first middle core part 23 toward the second middle core part 24. A second line Y is formed from the second lateral wall 26 toward the first lateral wall 25. The second line Y intersects at the middle point of the first line X. The first line X is perpendicular to the second line Y.

The third lateral wall 27 is disposed between the lower surface 212 of the upper cover core part 21 and the lower surface 222 of the lower cover core part 22. The third lateral wall 27 is connected with the third lateral wall 215 of the upper cover core part 21, a portion of the first lateral wall 213 and a portion of the second lateral wall 214. The cross-sectional area of the third lateral wall 27 is less than or equal to the cross-sectional area of the first middle core part 23. In this embodiment, the cross-sectional area of the third lateral wall 27 is greater than half of the cross-sectional area of the first middle core part 23. The fourth lateral wall 28 is disposed between the lower surface 212 of the upper cover core part 21 and the lower surface 222 of the lower cover core part 22. The fourth lateral wall 28 is connected with the fourth lateral wall 216, a portion of the first lateral wall 213 and a portion of the second lateral wall 214 of the upper cover core part 21. The fourth lateral wall 28 and the third lateral wall 27 are opposite to each other. The cross-sectional area of the fourth lateral wall 28 is less than or equal to the cross-sectional area of the first middle core part 23. In this embodiment, the cross-sectional area of the fourth lateral wall 28 is greater than half of the cross-sectional area of the first middle core part 23. In this embodiment, the third lateral core part 27, the first middle core part 23, the second middle core part 24 and the fourth lateral core part 28 are arranged in sequence. The cross-sectional area of the third lateral core part 27 is equal to the cross-sectional area of the fourth lateral core part 28. The cross-sectional area of the first lateral core part 25 is equal to the cross-sectional area of the second lateral core part 26. The cross-sectional area of the third lateral core part 27 is greater than the cross-sectional area of the first lateral core part 25.

The winding assembly 3 includes a first winding 31 and a second winding 32. The first winding 31 is disposed around the first middle core part 23. A portion of the first winding 31 is disposed between the first middle core part 23 and the second middle core part 24. Another portion of the first winding 31 is disposed between the first middle core part 23 and the third lateral core part 27. The second winding 32 is disposed around the second middle core part 24. A portion of the second winding 32 is disposed between the second middle core part 24 and the first middle core part 23. Another portion of the second winding 32 is disposed between the second middle core part 24 and the fourth lateral core part 28.

From above, the cross-sectional area of each lateral core part of the magnetic component 1 of the present disclosure is less than or equal to the cross-sectional area of the first middle core part 23. The magnetic component 1 generates nonlinear inductance variations at different currents for achieving different coupling coefficients. Consequently, when the magnetic component 1 operates at low current, the magnetic component 1 maintains a non-coupled high inductance. On the other hand, when the magnetic component 1 operates at high current, the magnetic component 1 achieves saturation and reduced inductance by the lateral core parts of the magnetic component 1. Simultaneously, the coupling degree is increased automatically, the AC current peak is reduced, and the magnetic flux is evenly distributed on the upper cover core part 21 or the lower cover core part 22. Consequently, the magnetic component 1 of the present disclosure has advantage of reducing the component loss and the conduction loss in the power supply. Moreover, the magnetic core assembly 2 of the magnetic component 1 of the present disclosure is a ferrite core assembly. Consequently, the design efficiency under high power density is enhanced, the iron loss is decreased, and the cost is reduced.

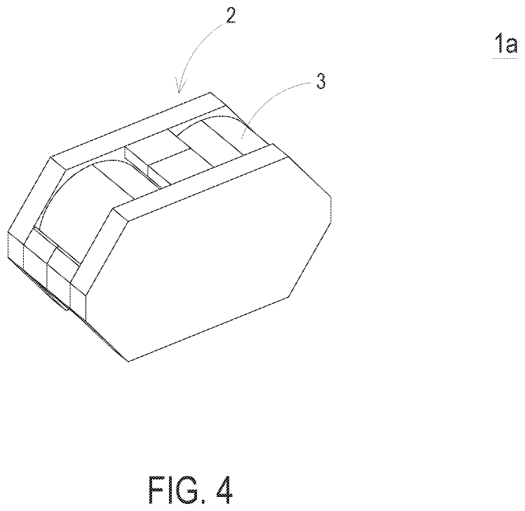

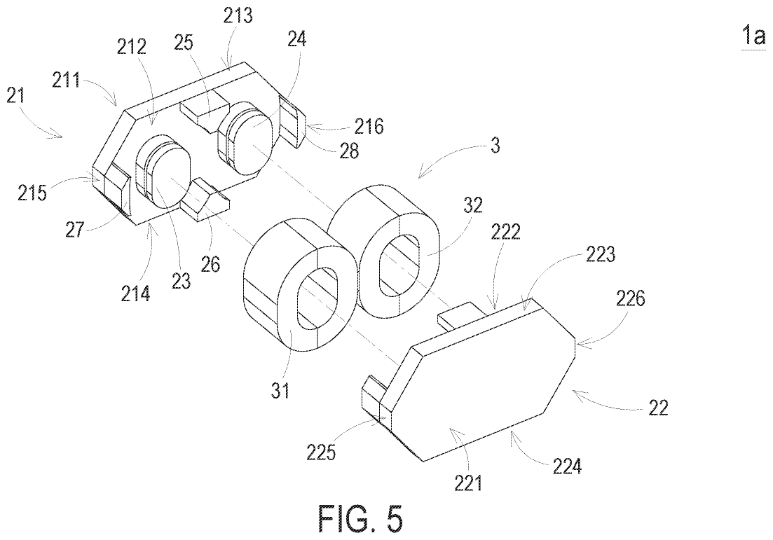

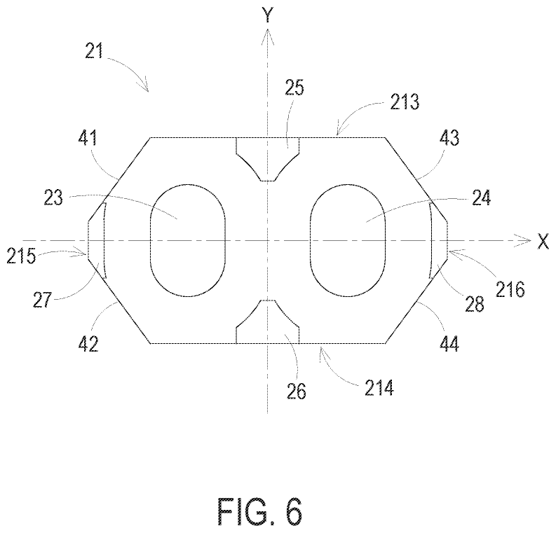

FIG. 4 is a schematic view illustrating a magnetic component according to a second embodiment of the present disclosure. FIG. 5 is a schematic exploded view illustrating the magnetic component of FIG. 4. FIG. 6 is a schematic cross-sectional diagram illustrating an upper cover core part of a magnetic core assembly of the magnetic component of FIG. 4. As shown in FIGS. 4 to 6, compared with the magnetic component 1 of FIGS. 1 to 3, the third lateral wall 215 of the upper cover core part 21 of the magnetic component la of this embodiment includes a first inclined surface 41 and a second inclined surface 42. The first inclined surface 41 is connected with the first lateral wall 213. The second inclined surface 42 is connected with the second lateral wall 214. In this embodiment, the third lateral core part 27 is connected with a portion of the first inclined surface 41 and a portion of the second inclined surface 42, but not connected with the first lateral wall 213 and the second lateral wall 214. In this embodiment, the fourth lateral wall 216 of the upper cover core part 21 of the magnetic component la includes a third inclined surface 43 and a fourth inclined surface 44. The third inclined surface 43 is connected with the first lateral wall 213. The fourth inclined surface 44 is connected with the second lateral wall 214. In this embodiment, the fourth lateral core part 28 is connected with a portion of the third inclined surface 43 and a portion of the fourth inclined surface 44, but not connected with the first lateral wall 213 and the second lateral wall 214. Certainly, the lower cover core part 22 of the magnetic component la includes inclined surfaces, and is not redundantly described hereinafter. Compared with the first embodiment, in this embodiment, the cross-sectional area of the third lateral core part 27 is less than the cross-sectional area of the first lateral core part 25. Consequently, the magnetic component la of this embodiment achieves saturation at different currents by varying the cross-sectional area of the lateral core parts positioned at different locations. The magnetic flux between the first middle core part 23 and the second middle core part 24 is varied so as to form a coupling coefficient different to the coupling coefficient of the magnetic component I of the first embodiment. Namely, the relationship between the cross-sectional area of the third lateral core part 27 and the cross-sectional area of the first lateral core part 25 is varied according to product requirement so as to achieve saturation at different currents. Consequently, the magnetic flux between the first middle core part 23 and the second middle core part 24 is varied so as to form different coupling coefficient. Moreover, in this embodiment, the cross-sectional area of the third lateral core part 27 is less than or equal to half of the cross-sectional area of the first middle core part 23. The cross-sectional area of the fourth lateral core part 28 is less than or equal to half of the cross-sectional area of the first middle core part 23.

As mentioned above, the cross-sectional area of each lateral core part of the magnetic component of the present disclosure is less than or equal to the cross-sectional area of the first middle core part. The magnetic component generates nonlinear inductance variations at different currents for achieving different coupling coefficients. Consequently, when the magnetic component operates at low current, the magnetic component maintains a non-coupled high inductance. On the other hand, when the magnetic component operates at high current, the magnetic component achieves saturation and reduced inductance by the lateral core parts of the magnetic component. Simultaneously, the coupling degree is increased automatically, the AC current peak is reduced, and the magnetic flux is evenly distributed on the upper cover core part or the lower cover core part. Consequently, the magnetic component of the present disclosure has advantage of reducing the component loss and the conduction loss in the power supply. Moreover, the magnetic core assembly of the magnetic component of the present disclosure is a ferrite core assembly. Consequently, the design efficiency under high power density is enhanced, the iron loss is decreased, and the cost is reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A magnetic component, comprising:
a magnetic core assembly, comprising:
an upper cover core part comprising a plurality of lateral walls;
a lower cover core part, wherein the lower cover core part and the upper cover core part are opposite to each other;
a first middle core part disposed between the upper cover core part and the lower cover core part, wherein a first distance is formed between the first middle core part and any one of the plurality of lateral walls of the upper cover core part;
a second middle core part disposed between the upper cover core part and the lower cover core part, wherein a second distance is formed between the second middle core part and any one of the plurality of lateral walls of the upper cover core part, and a third distance is formed between the second middle core part and the first middle core part; and
a first lateral core part disposed between the upper cover core part and the lower cover core part and connected with at least one of the plurality of lateral walls of the upper cover core part, wherein a cross-sectional area of the first lateral core part is less than or equal to a cross-sectional area of the first middle core part; and
a winding assembly, comprising:
a first winding disposed around the first middle core part; and
a second winding disposed around the second middle core part.

2. The magnetic component according to claim 1, wherein the magnetic core assembly is a ferrite core assembly.

3. The magnetic component according to claim 1, wherein the cross-sectional area of the first middle core part is equal to a cross-sectional area of the second middle core part.

4. The magnetic component according to claim 1, wherein the plurality of lateral walls of the upper cover core part comprise a first lateral wall, a second lateral wall, a third lateral wall and a fourth lateral wall, the first lateral wall and the second lateral wall are opposite to each other, the third lateral wall and the fourth lateral wall are opposite to each other and disposed between the first lateral wall and the second lateral wall, and the first lateral core part is at least connected with the first lateral wall.

5. The magnetic component according to claim 4, wherein the magnetic core assembly comprises a second lateral core part disposed between the upper cover core part and the lower cover core part, the second lateral core part and the first lateral core part are opposite to each other, and the second lateral core part is at least connected with the second lateral wall, wherein a cross-sectional area of the second lateral core part is less than or equal to half of the cross-sectional area of the first middle core part.

6. The magnetic component according to claim 5, wherein a first line is formed from the first middle core part toward the second middle core part, and a second line is formed from the first lateral core part toward the second lateral core part, wherein the second line intersects at a middle point of the first line, and the first line is perpendicular to the second line.

7. The magnetic component according to claim 4, wherein the magnetic core assembly comprises a third lateral core part and a fourth lateral core part, the third lateral core part is disposed between the upper cover core part and the lower cover core part, and the third lateral core part is connected with the third lateral wall, wherein a cross-sectional area of the third lateral core part is less than or equal to half of the cross-sectional area of the first middle core part, the fourth lateral core part is disposed between the upper cover core part and the lower cover core part, the fourth lateral core part and the third lateral core part are opposite to each other, the fourth lateral core part is connected with the fourth lateral wall, and a cross-sectional area of the fourth lateral core part is less than or equal to half of the cross-sectional area of the first middle core part.

8. The magnetic component according to claim 7, wherein the third lateral core part, the first middle core part, the second middle core part and the fourth lateral core part are arranged in sequence.

9. The magnetic component according to claim 7, wherein the third lateral core part is connected with the third lateral wall, a portion of the first lateral wall and a portion of the second lateral wall, and the fourth lateral core part is connected with the fourth lateral wall, a portion of the first lateral wall and a portion of the second lateral wall.

10. The magnetic component according to claim 7, wherein the third lateral wall comprises a first inclined surface and a second inclined surface, the first inclined surface is connected with the first lateral wall, and the second inclined surface is connected with the second lateral wall, wherein the third lateral core part is connected with a portion of the first inclined surface and a portion of the second inclined surface, the fourth lateral wall comprises a third inclined surface and a fourth inclined surface, the third inclined surface is connected with the first lateral wall, the fourth inclined surface is connected with the second lateral wall, and the fourth lateral core part is connected with a portion of the third inclined surface and a portion of the fourth inclined surface.
